(19) United States
(12) Patent Application Publication
(10) Pub. No.: US 2010/0237542 A1
(43) Pub. Date: Sep. 23, 2010

(54) Child's fabric toy with heat activated expandable form

(76) Inventor: Wen Zhang, Nanjing (CN)

Correspondence Address: TOD R NISSLE, PO BOX 55630, PHOENIX, AZ, 85078, US

(21) Appl. No.: 12/383,317

(22) Filed: Mar. 23, 2009

(51) Int. Cl. B29C 67/24

(52) U.S. Cl. 264/342 R

(57) ABSTRACT

A method for producing and distributing a child's toy encloses an expandable foam composition in a pliable fabric skin. The toy is compressed into a deflated configuration to form an inflatable toy and is shipped to a selected destination. The inflatable toy is delivered to a distributor and sold to an end user. The end user activates the foam to inflate the toy.

This invention relates to toys for children.

More particularly, the invention relates to a child's fabric toy and a method of producing and distributing the same.

A variety of plush and other fabric toys have been produced for many years. One existing motivation is to improve methods of manufacturing and delivering toys. Although this motivation has existed for years, innovation in the production and distribution of plush toys appears slow at best, and new toys and distribution methods that are successful in the market appear only intermittently.

Accordingly, it would be highly desirable to provide an improved fabric toy and method to produce and distribute the toy.

These and other, further and more specific objects, of the invention will be apparent to those skilled in the art from the following detailed description thereof, when taken in conjunction with the drawings in which

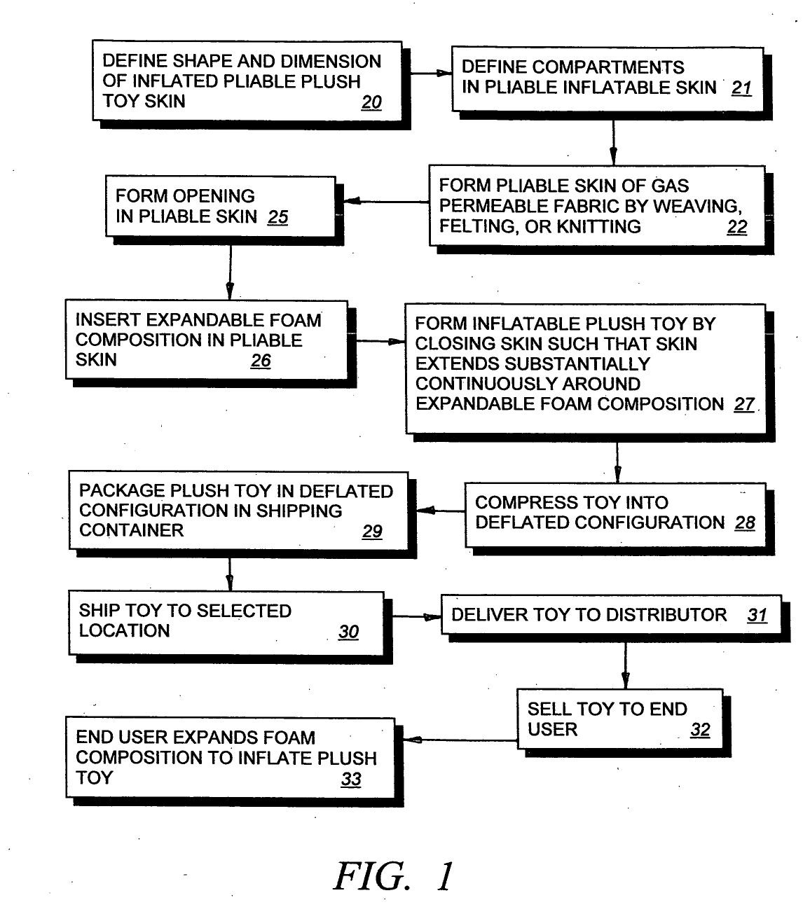

FIG. 1 is a block flow diagram illustrating presently preferred embodiments of the invention;

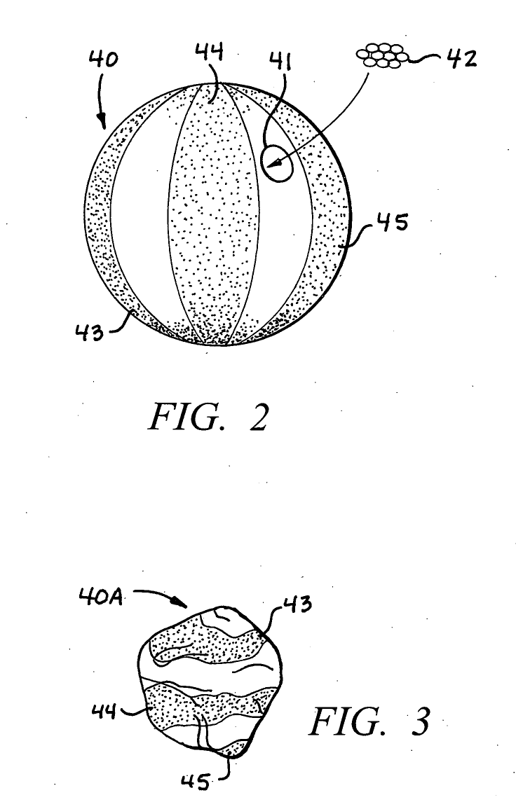

FIG. 2 is a perspective view illustrating a pliable beach ball plush fabric skin constructed in accordance with the invention;

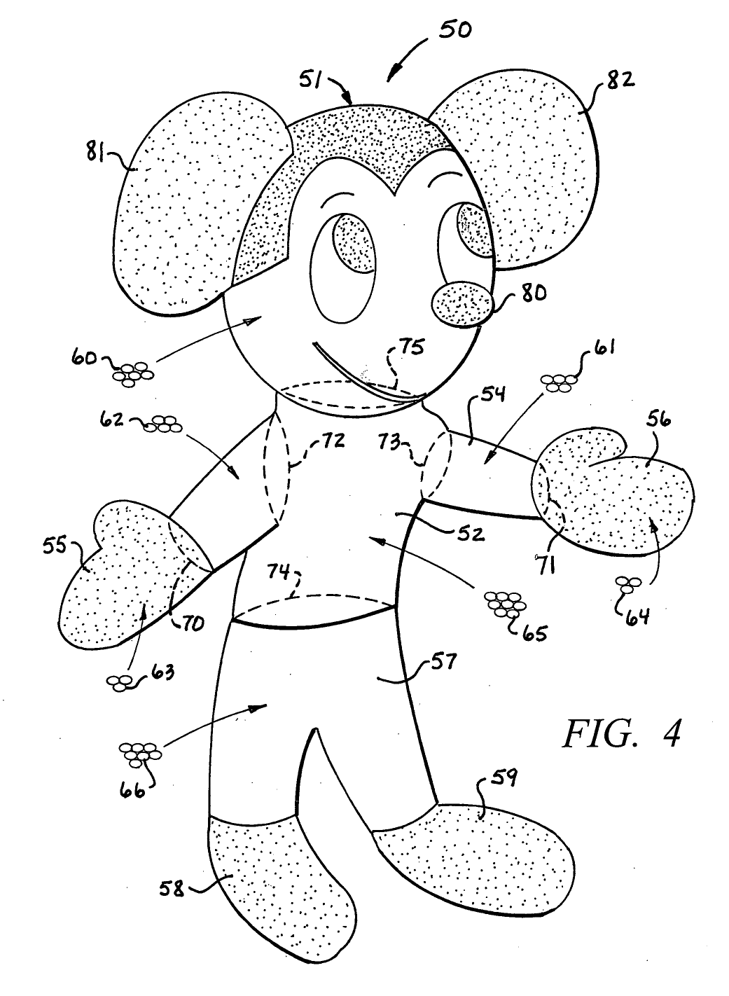

FIG. 3 is a perspective view illustrating an inflatable plush fabric toy including the plush fabric skin of FIG. 2, said toy being compressed and deflated for shipping;

FIG. 4 is a perspective view illustrating a multi-compartment inflatable plush fabric skin constructed in accordance with the invention;

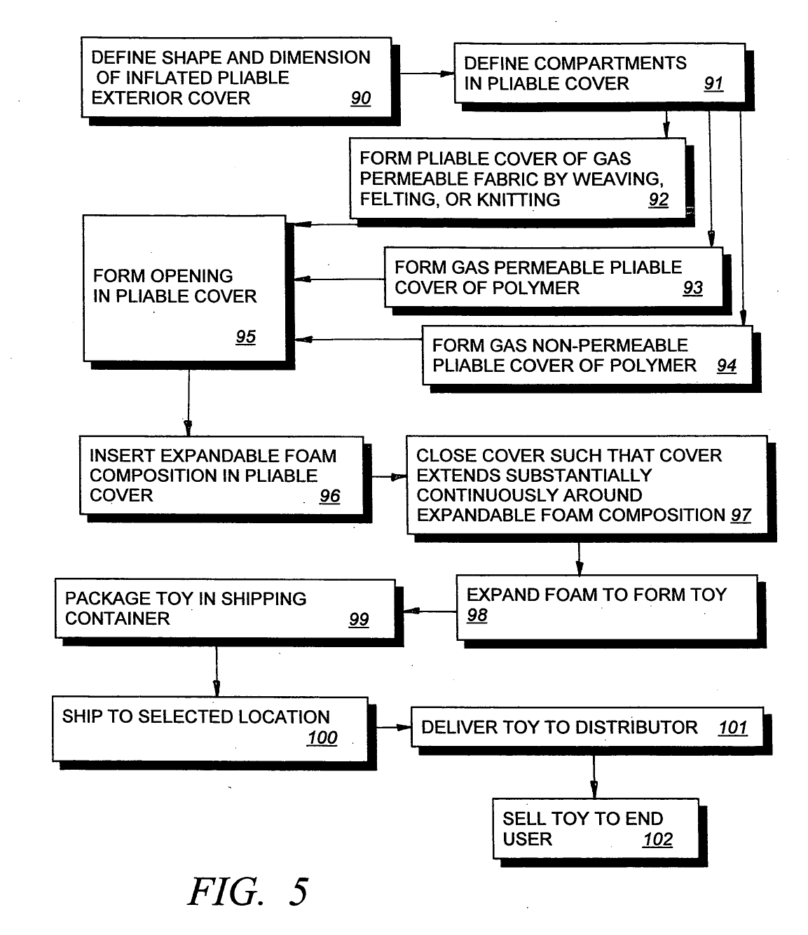

FIG. 5 is a block flow diagram illustrating another embodiment of the invention; and,

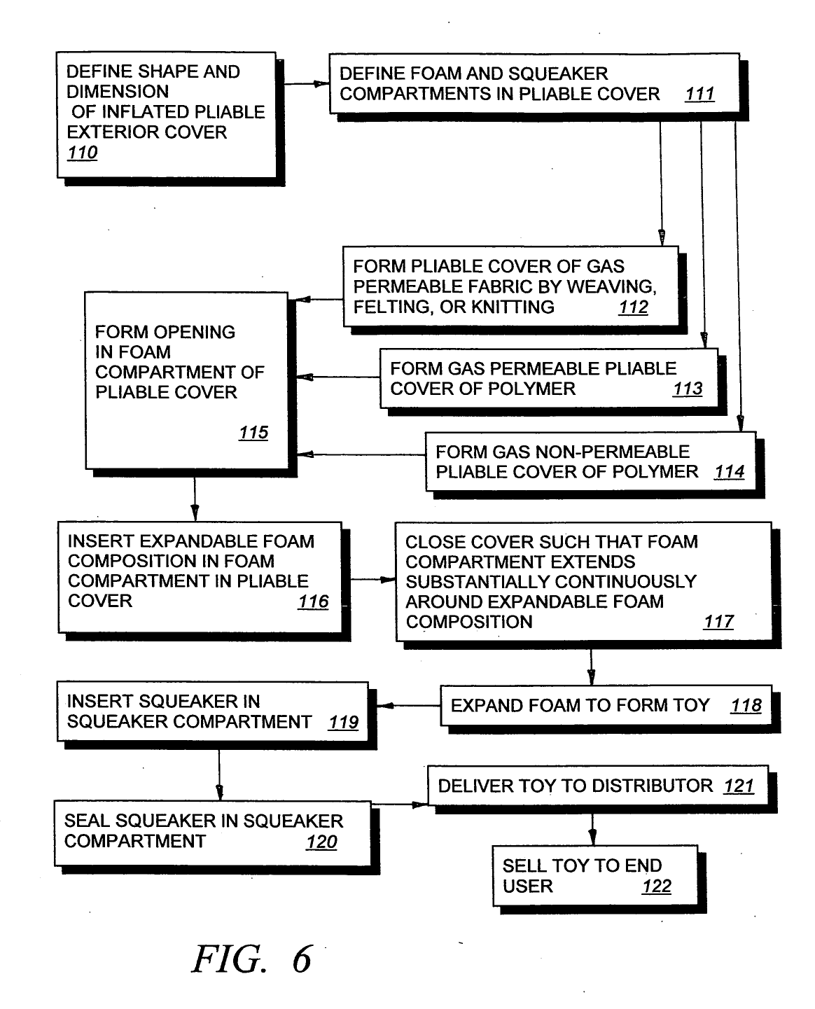

FIG. 6 is a block flow diagram illustrating still a further embodiment of the invention.

Briefly, in accordance with the invention, I provide an improved method for producing and distributing a child's toy. The method comprises the steps of defining the shape and dimension of an inflated toy skin; forming a substantially continuous pliable skin of a gas permeable fabric, the skin cover generally circumscribing and enclosing a volume of gas; forming an opening in the pliable fabric skin; inserting an expandable foam composition in the pliable fabric skin; closing the opening such that the pliable fabric skin extends substantially continuously around the expandable foam composition to produce an inflatable toy; compressing the inflatable toy into a deflated configuration; packaging in a shipping container the inflatable toy in the deflated configuration; shipping the container to a selected destination; delivering the inflatable toy to a distributor; selling the inflatable toy to an end user having a residence; and, activating, in the end user's residence, the foam composition to inflate the inflatable toy.

Turning now to the drawings, which illustrated the presently preferred embodiments of the invention for the purpose of illustrating the use thereof and not be way of limitation of the scope of the invention, and in which like reference character refer to corresponding elements throughout the several views, the method illustrated in FIG. 1 includes the step 20 of “define shape and dimension of inflated pliable plush toy skin”, step 21 of “define compartments in pliable inflatable skin, step 22 of “form pliable cover of gas permeable fabric by weaving, felting, or knitting”, step 25 of “form opening in pliable skin”, step 26 of “insert expandable foam composition in pliable skin”, step 27 of “form inflatable plush toy by closing skin such that skin extends substantially continuously around expandable foam composition, step 28 of “compress toy into deflated configuration”, step 29 of “package plush toy in deflated configuration in shipping container”, step 30 of “ship toy to selected location”, step 31 of “deliver toy to distributor”, step 32 to “sell toy to end user”, and step 33 to “end user expands foam composition to inflate plush toy.”

As used herein, a plush toy is a toy in which the exterior skin is a material that includes pile which is at least one thirty-second of an inch long, is preferably at least one sixteenth of an inch long, and more preferably is at least one eighth of an inch (0.3 cm) long.

As used herein, fabric comprises any type of cloth made from woven, knitted, or felted thread or fibers. The thread or fibers can be natural or synthetic. Fabric also includes material with pile that is at least one thirty-second of an inch long.

A toy produced in accordance with the invention normally includes an exterior skin that includes fabric such that at least 50% of the area covered by the skin is fabric, preferably at least 60% of the area covered by the skin is fabric, more preferably at least 75% of the area covered by the skin is fabric, and most preferably at least 90% of the area covered by the skin is fabric.

In step 20, the desired shape and dimension of the exterior skin of a child's plush toy is determined for when the plush toy is inflated, and can vary as desired. The plush toy typically will be shaped like a animal, star, ball or some other object that often attracts the interest of children.

In step 21, the number of hollow compartments in the plush toy are defined. Since compartments in the plush toy will be filled, partially or completely, with expanded foam, it sometimes is desirable to utilize a plurality of separate compartments in the plush toy to insure that foam reaches all desired areas within the plush toy exterior skin. For example, if the plush toy has a body and arms and legs that extend outwardly from the body, the inner volume of the arms and legs typically will be less than the volume of the body of the toy. If an expandable foam composition is only utilized in the body of the plush toy, the foam may not expand sufficiently to fill the arms and legs. Accordingly, the arms and legs can be sealed from the body of the toy and a first quantity of an expandable foam composition put in one leg, a second quantity of an expandable foam composition placed in an arm, a third quantity of an expandable foam composition placed in the body, and so on. This would help to insure that each compartment of the plush toy is filled with foam when the foam expands.

In step 22, a pliable fabric skin 40 (FIG. 2) is produced using, ay least in part, weaving, felting, or knitting. The fabric skin 40 preferably, but not necessarily, is gas permeable. The fabric skin 40 circumscribes a gas-filled volume, where the gas ordinarily is air.

Any desired material can be utilized to make the pliable fabric skin. Since, however, the toy is intended for children, soft plush fabrics are preferred.

In step 25, an opening 41 (FIG. 2) is formed in the pliable fabric skin. The opening 41 required in step 25 can be formed in the during the manufacture of the fabric skin in steps 22 to 24, or can be formed after the fabric skin is produced in steps 22 to 24.

In step 26, an expandable foam composition 42 (FIG. 2) is inserted through the opening 41 formed in step 25 and inside the pliable fabric skin to fill at least a portion of the volume circumscribed by the skin.

In step 27, an inflatable plush toy is produce by stitching shut or otherwise covering the opening 41 so that the fabric skin 50 extends substantially continuously around the volume within the skin. In one embodiment of the invention, one or more openings are formed in and remain in the fabric skin so that when the foam composition expands, some of the foam composition extrudes out through the openings. This embodiment of the invention is not, however, presently preferred.

In step 28, the inflatable plush toy is compressed into a deflated configuration 40A (FIG. 3). When the foam composition in the cover is activated, the foam causes the cover to expand. If the cover is, when in its deflated configuration, rolled up, foam produced when the foam composition is activated can cause the cover to open or unroll or unfold, possibly, by way of example and not limitation, the way the pedals of a flower bud open when the flower blooms.

In step 29, the deflated plush toy is packaged or placed in a shipping container.

In step 30, the shipping container is transported to a selected destination.

Once the shipping container reaches its destination, the deflated plush toy is removed delivered to a distributor 31. The toy is sold 32 to an end user, either by the distributor or by a second distributor to whom the first distributor sells the toy. The end user then, in step 33, takes the plush toy to his or her residence and activates the foam with heat, microwaves, etc. to activate the expandable foam composition so that gas is formed and foam is formed. The foam is allowed to cure. The composition 51 expands, inflates, and preferably inflates and substantially fills fabric skin 40. As noted, skin 40 may include two or more separate compartments, each charged with foam composition 51 that expands to fill the compartment. The inflated toy can be wrapped or packaged for sale and then, in step 32, delivered to a distributor. The distributor sells the toy to an end user in step 33.

A specific cover 50 having a shape and dimension is depicted for purposes of illustration in FIG. 2. Cover 50 is hollow and is cylindrically shaped, and is comprises of a pliable fabric. Cover 50 includes opening 54 at one end. The other end 56 of cylindrical cover 50 is closed.

The cover 50 is charged with foam pellets 51 that, when heated, are activated and produce gas and expand into a foam that fills cover 50. After the foam pellets 51 are placed inside cover 50, panel member 52 is stitched over opening 54 to close opening 54. Foam pellets 51 presently preferably comprise a composition that is activated with heat, but the composition utilized can be activated by microwaves or any other desired means. In one embodiment of the invention, the pellets 51 (or other foam composition) are activate by microwaves. In another embodiment of the invention, cover 50 is liquid permeable and is wetted so that water contacts and activates pellets 51. After pellets produce the desired expanded foam, the cover 50 and foam are allowed to dry.

After opening 54 is closed with panel member 52, pliable cover 50 is deflated into a flatter configuration as generally illustrated by reference character 53 in FIG. 2. This typically is accomplished by compressing cover 50 so that some of the air inside cover 50 escapes outwardly through the gas permeable fabric comprising cover 50. In some case, pliable cover 50 may already be in a flattened configuration so that little, if any, compression is required to flatten or compress cover 50 to facilitate packaging 40 (FIG. 2) the cover 50 in a shipping container. When cover 50 is in a deflated configuration, this facilitates shipping larger quantities of cover 50 to intended destination because cover(s) 50 would, if inflated, occupy substantially more space in a shipping container. The cover 50 is shipped 41, and is, after the shipping container reaches its desired destination, heated 42 to activate the foam pellets 51 to produce foam and inflate cover 50 to produce the desired inflated toy. The inflated toy can then, if desired, be packaged for sale 43 and delivered 44 to a distributor for sale to an end user or, if the distributor is a wholesaler, to a retailer for sale to the end user.

One particularly desirable feature of the method of FIGS. 1 and 2 is that a mold is not required to make the toy.

In an alternate embodiment of the invention, the foam composition in a cover 50 is activated and expands to produce a toy prior to shipping the toy in step 30. In this embodiment of the invention, the inflated cover 50 is not compressed into a deflated configuration 28, although if the foam inside cover 50 is resilient, it is possible that the cover 50 can be compressed to a certain extent.

In one embodiment of the invention, composition 51 is applied to the inner side of cover 50 by heat bonding/thermoforming or co-extrusion. Consequently, in this embodiment of the invention, step 26 is accomplished during the formation of a cover 50; namely, because when cover 50 is constructed, the inner side of cover 50 (and the composition 51 formed on the inner side of cover 50) faces inwardly toward and contacts the volume circumscribed by cover 50.

The foam composition 42 used to charge a fabric skin 40 can vary as desired and can be in a solid, semi-solid, or liquid form. Pre-cast solid pellets are presently preferred. When skin 40 comprises a pliable fabric, a solid foam composition 42 is preferred. Composition 42 is activated by heat, time, pressure, moisture, or any other desired mechanism. When composition is activated by heat, the activation temperature can vary as desired but is ordinarily greater than normal ambient temperatures, in part because when deflated fabric skins 40 are being shipped during step 30 in FIG. 2, it is important to prevent the accidental activation of the composition 42. On the other hand, it is desirable not to have the activation to high, this in order to prevent damage to a fabric or polymer used to produce skin 40. The activation preferably permits a composition to expand and cure. Compositions 42 are available which will, when activated, expand from 0 to 1500 percent. Compositions 42 which expand to a greater degree generally produced a final cured foam that are light in weight per unit volume than are compositions which expand to a lesser degree.

By way of example, composition 42 can comprise an epoxy-based material and may include an ethylene coppolymer or terpolymer. L & L Products of Romeo, Mich. produces such compositions 42 under the designations L5206, L5207, L5208 and L5209. Such compositions 42 are usually processed initially as thermoplastic materials prior to curing. After curing, the resulting foams usually becomes thermoset materials. Other possible materials include, without limitation, polyurethane materials, phenoxy materials, copolymers and terpolymers with at least one monomer typ of an alpha-olefin, polyolefin material, and phenol/formaldehyde materials. Such materials can produce foams with good corrosion and humidity resistance, high stiffness, and high strength. As noted, material which produce elastic and resilient foams can also be utilized.

It is presently preferred that composition 42 be heat-activated and, when activated, expand and cure by foaming (i.e., producing gas) and undergoing cross-linking reactions. While the resulting cured foam composition can be elastic and resilient, it is also preferred that the cured foam composition be rigid, or substantially rigid so as to improve the structural strength of the resulting dog toy or other animal toy.

In another embodiment of the invention, the foam composition 42 in a plush toy is activated before step 30 so that the plush toy is inflated prior to shipping.

In a further embodiment of the invention, the foam composition 42 in a plush toy is activated after step 30 and before step 31 so that the plush toy is inflated prior to being sold to the end user.

FIG. 4 illustrates another plush toy 50 constructed in accordance with the invention and including an exterior plush fabric skin circumscribing a plurality of separate compartments. The plush toy 50 is illustrated in FIG. 4 as if the foam compositions inside the various compartments have been activated and have inflated toy 50.

The first hollow compartment of toy 50 comprises the head of the toy and is circumscribed by pliable plush fabric skin 51. Nose 80 and ears 81 and 82 are attached to skin 51 but are not plush fabric and are not intended to filled with a foam composition when the foam composition is activated. Expandable foam composition 60 is inserted within skin 51. P The second hollow compartment of toy 50 comprises the body of the toy and is circumscribed by pliable plush fabric skin 31. Expandable foam composition 65 is inserted within skin 51. Oval panel member 75 separates the body of the toy from the head of the toy.

The third hollow compartment of toy 50 comprises the right arm of the toy and is circumscribed by pliable plush fabric skin 53. Expandable foam composition 62 is inserted within skin 53. Oval panel member 72 separates the right arm of the toy from the body of the toy.

The fourth hollow compartment of toy 50 comprises the left arm of the toy and is circumscribed by pliable plush fabric skin 54. Expandable foam composition 61 is inserted within skin 53. Oval panel member 73 separates the left arm of the toy from the body of the toy.

The fifth hollow compartment of toy 50 comprises the right hand of the toy and is circumscribed by pliable plush fabric skin 55. Foam composition 63 is inserted within skin 55. Oval panel member 70 separates the right hand of the toy from the right arm of the toy.

The sixth hollow compartment of toy 50 comprises the left hand of the toy and is circumscribed by pliable plush fabric skin 56. Foam composition 64 is inserted within skin 56. Oval panel member 71 separates the left hand of the toy from the left arm of the toy.

The seventh hollow compartment of toy 50 comprises the legs of the toy and is circumscribed by pliable plush fabric skin 57. Foam composition 66 is inserted within skin 57. Oval panel member 74 separates the legs of the toy from the body of the toy. Each panel member 70-74 can be fabricate from fabric, polymer, or any other desired material and can or can not be gas permeable.

As would be appreciated by those of skill in the art, a variety of objects other than pet toys can be fabricated utilizing the method of the invention. Such objects could include, for example, life preservers, life rafts, furniture cushions, dog beds, and camping beds. In addition, a sheet or panel of cloth or other material can be provided on one or both sides with a coating of a foam composition that will, when activated, expand in a direction outwardly away from the layer of cloth. Such a cloth-foam laminate could be used as insulation or sound-proofing in a house, as one or more walls of a tent, as an emergency blanket, etc.

When a new foam filled toy is produced, in particular a toy with a relatively stiff foam core, the shape and dimension of the toy, including the shape and dimension of the core, is designed first, after which the mold necessary to produce the foam core is designed and built. Such a mold typically costs at least $10,000.00 to $15,000.00 and requires about thirty days to build. Further, the production of a foam core using the mold can require a longer than hoped for period of time because the foam core can require ten to fifteen minutes to cure before it can be removed from the mold. And, recouping the cost of the mold can require the sale of thousands of units of the toy. The embodiment of the invention illustrated in FIG. 5 provides a way to produce rapidly a new toy without have to incur the cost of constructing and utilizing a mold. The method of FIG. 5 includes the steps of “define shape and dimension of inflated pliable exterior cover” 90, “define compartments in pliable cover” 91, “form pliable cover of gas permeable fabric by weaving, felting, or knitting” 92, “form permeable pliable cover of polymer” 93, “form gas non-permeable pliable cover of polymer” 94, “form opening in pliable cover” 95, “insert expandable foam composition in pliable cover” 96, “close cover such that cover extends substantially continuously around expandable foam composition” 97, “expand foam to form toy” 98, “package toy in shipping container” 99, “ship toy to selected location” 100, “deliver toy to distributor” 101, and “sell toy to end user” 102.

In step 90, the desired shape and dimension of the exterior cover of the toy is determined for when the toy is inflated, and can vary as desired.

In step 91, the number of hollow compartments in the toy are defined. Since compartments in the toy will be filled, partially or completely, with expanded foam, it sometimes is, as discussed above, desirable to utilize a plurality of separate compartments in the toy to insure that foam reaches all desired areas inside the toy cover.

In step 92, a pliable fabric cover is produced by weaving, felting, or knitting. The fabric cover preferably, but not necessarily, is gas permeable. The fabric cover circumscribes a gas-filled volume, where the gas ordinarily is air.

As an alternative to step 92, in step 93 the pliable cover is formed of a gas permeable polymer.

As still another alternative to step 92, in step 94 the pliable cover is formed from a polymer that is not permeable to gas.

Any desired material can be utilized to make the pliable cover.

In step 95, an opening is formed in the pliable cover. The opening can be formed during the manufacture of the cover in steps 92 to 94, or can be formed after the cover is produced in steps 92 to 94.

In step 96, an expandable foam composition is inserted through the opening formed in step 95 and is inserted inside the pliable cover to fill at least a portion of the volume circumscribed by the cover.

In step 97, the cover is stitched shut or otherwise covered so that the pliable cover extends substantially continuously around the volume within the cover. In one embodiment of the invention, one or more openings are formed in and remain in the cover so that when the foam composition expands, some of the foam composition extrudes out through the openings. This embodiment of the invention is not, however, presently preferred.

In step 98, the foam composition is expanded to form an inflated toy. A great virtue of this embodiment of the invention is that as soon as a new toy is designed, the fabric cover can be immediately produced, an opening formed (if necessary) in the cover, an expandable foam composition placed in the cover, the opening sealed, and the foam activated to cause it to expand and fill the fabric cover. There is no waiting period to permit a mold to be designed, constructed, and operated. As described above in connection with another embodiment of the invention, after the fabric cover is charged with the expandable foam composition, the cover can be transported to another desirable location before the foam composition is activated and expanded.

The embodiment of the invention illustrated in FIG. 6 includes the steps of “define shape and dimension of inflated pliable exterior cover” 110, “define foam and squeaker compartments in pliable cover” 111, “form pliable cover of gas permeable fabric by weaving, felting, or knitting” 112, “form permeable pliable cover of polymer” 113, “form gas non-permeable pliable cover of polymer” 114, “form opening in foam compartment of pliable cover” 115, “insert expandable foam composition in foam compartment in pliable cover” 116, “close cover such that foam compartment extends substantially continuously around expandable foam composition” 117, “expand foam to fill foam compartment” 118, “insert squeaker in squeaker compartment” 119, “seal squeaker in squeaker compartment” 120, “deliver toy to distributor” 121, and “sell toy to end user” 122.

In step 110, the desired shape and dimension of the exterior cover of the toy is determined for when the toy is inflated, and can vary as desired.

In step 111, the hollow compartments in the toy are defined and include a foam compartment and a squeaker compartment. The foam and squeaker compartments are, in this embodiment of the invention, separate from each other in the event the foam composition becomes too warm and can damage the squeaker, or in the event the chemical composition or other physical property of the foam composition or foam produced by the composition will damage the squeaker. Since the foam compartments in the toy will be filled, partially or completely, with expanded foam, it sometimes is, as discussed above, desirable to utilize a plurality of separate foam compartments in the toy to insure that foam reaches all desired areas inside the toy cover.

In step 112, a pliable fabric cover is produced by weaving, felting, or knitting. The fabric cover preferably, but not necessarily, is gas permeable. The fabric cover circumscribes a gas-filled volume, where the gas ordinarily is air.

As an alternative to step 112, in step 113 the pliable cover is formed of a gas permeable polymer.

As still another alternative to step 112, in step 114 the pliable cover is formed from a polymer that is not permeable to gas.

Any desired material can be utilized to make the pliable cover.

In step 115, an opening is formed in the foam compartment of the pliable cover. The opening can be formed during the manufacture of the cover in steps 112 to 114, or can be formed after the cover is produced in steps 112 to 114.

In step 116, an expandable foam composition is inserted through the opening formed in step 115 and into the foam compartment of the pliable cover to fill at least portion of the volume circumscribed by the foam compartment.

In step 117, the cover is stitched shut or otherwise covered so that the portion of the pliable cover comprising the foam compartment extends substantially continuously around the volume within the foam compartment. In one embodiment of the invention, one or more openings are formed in and remain in the portion of the cover comprising the foam compartment so that when the foam composition expands, some of the foam composition extrudes out through the openings. This embodiment of the invention is not, however, presently preferred.

In step 118, the foam composition in the foam compartment is expanded to form an inflated toy.

In step 119 a squeaker is inserted in the squeaker compartment. In step 120 the squeaker is sealed in the squeaker compartment. This can be accomplished by stitching the squeaker compartment closed, by filling the squeaker compartment with foam, etc. or by any other desired means. When the squeaker is sealed in the squeaker compartment, one end of the squeaker can, if desired be positioned in an access opening in the fabric cover and in communication with ambient air. This often is desirable when the squeaker functions by drawing air into and expelling air from a bladder that comprises a portion of the squeaker. If, on the other hand, the squeaker is an electronic device that is activated by motion or when foam surrounding the squeaker is compressed, then providing an access opening in the fabric cover in the toy may not be necessary and the squeaker can be completely surrounded and enclosed by foam or another solid material or gas that fills the squeaker compartment.

In step 121 the toy is delivered to a distributor, after which the toy is sold 122 to an end user.

In one embodiment of the invention, an expandable foam toy of the type described above is packaged in a frangible container that is shaped like an egg. The foam in the foam toy has not been activated and has not expanded when the foam toy is initially packaged in the frangible container. The foam toy can, by way of example and not limitation, take on the shape of a chick when the foam in the toy is activated and expands. The container and foam toy are sold as a unit to an end user. When the end user places the frangible container and foam toy in a microwave to activate the foam (or activates the foam in some other manner), the foam expands, the foam toy takes on the shape of a chick and breaks the frangible container. The frangible container has to be broken in order for the foam toy to take on its full size. The container is scored or otherwise configured to insure that the container will break when the foam in the toy is activated and expands.

As would be appreciated by those of skill in the art, any toy containing expandable foam in a hollow compartment can also include a hollow compartment(s) in which there is no expandable foam, and/or can include a portion(s) which is not hollow.

Having described my invention in such terms as to enable those of skill in the art to make and use the invention, and having described the preferred embodiments and best mode thereof, I claim:

1. (canceled)

2. A method to produce a child's toy, comprising the steps of
(a) defining the shape and dimension of an inflated toy skin having at least a first hollow compartment and a second hollow compartment separate from said first hollow compartment, said first and second compartments in said inflated skin each being inflated and being sealed from an adjacent compartment;
(b) forming a substantially continuous pliable skin of a gas permeable fabric, said skin generally circumscribing each of said first and second hollow compartments and enclosing a volume of gas in each of said compartments;
(c) forming at least one opening in said pliable skin;
(d) inserting through said opening a first quantity of a solid composition in said first hollow pliable deflated compartment to partially fill said first deflated compartment, said solid composition when activated with heat producing a gas, producing a foam, expanding an amount sufficient to inflate and fill said first hollow pliable compartment, and curing;
(e) inserting through said opening a second quantity of said solid composition in said second hollow pliable compartment to partially fill said second compartment, said second quantity of said solid composition when activated with heat producing a foam, expanding an amount sufficient to inflate and fill said second hollow pliable compartment, and curing;
(f) producing an inflatable toy by closing said opening such that said pliable skin extends substantially continuously around said first and second hollow compartments and around said first and second quantities of said solid composition in said first and second hollow compartments,
(g) compressing, without heat activating said first and second quantities of said solid composition, said inflatable toy into a deflated configuration;
(h) packaging in a shipping container said inflatable toy in said deflated configuration;
(i) shipping said container to a selected destination;
(j) delivering said inflatable toy to a distributor;
(k) selling said inflatable toy to an end user having a residence; and,
(l) producing an inflated toy by, in said residence, activating with heat said first and second quantities of said solid composition in said inflatable toy to produce a gas, produce a foam, and to expand an amount sufficient to inflate and fill said first and second hollow pliable compartments and to cure.
